(19) United States
(12) Patent Application Publication
(10) Pub. No.: US 2024/0418822 A1
(43) Pub. Date: Dec. 19, 2024

(54) WIRELESS COMMUNICATION METHOD AND DEVICE

(71) Applicant: GUANGDONG OPPO MOBILE TELECOMMUNICATIONS CORP., LTD., Dongguan (CN)

(72) Inventor: Yang LIU, Dongguan (CN)

(21) Appl. No.: 18/816,656

(22) Filed: Aug. 27, 2024

Related U.S. Application Data
(63) Continuation of application No. PCT/CN2022/078839, filed on Mar. 2, 2022.

(51) Int. Cl. G01S 7/00; G01S 13/86; H04W 8/24

(52) U.S. Cl. CPC G01S 7/006; G01S 13/86; H04W 8/24

(57) ABSTRACT

Embodiments of this application provide a wireless communication method and a device. A sensing device can learn, based on a measurement result, whether there is a line of sight. In this way, the sensing device may determine whether to activate a wireless sensing service. The wireless communication method includes the following processes. The sensing device determines, based on a first measurement result, whether to activate the wireless sensing service. The first measurement result includes indication information indicating whether there is a line of sight.

### CROSS-REFERENCE TO RELATED APPLICATIONS

This application is a continuation of International Application No. PCT/CN2022/078839, filed on Mar. 2, 2022, the disclosure of which is hereby incorporated by reference in its entirety.

### TECHNICAL FIELD

Embodiments of this application relate to the field of communications, and more specifically, to a wireless communication method and a device.

### BACKGROUND

A new radio (NR) system supports a sensing capability. Wireless sensing can be performed only when there is a slightly occluded or even non-occluded line of sight channel between a sensing node and a target device. How to determine whether there is a line of sight channel between a sensing node and a target device is an urgent problem to be solved.

### SUMMARY

Embodiments of this application provide a wireless communication method and a device. A sensing device can learn, based on a measurement result, whether there is a line of sight. In this way, the sensing device can determine whether to activate a wireless sensing service.

According to a first aspect, a wireless communication method is provided, and the method includes: determining, by a sensing device based on a first measurement result, whether to activate a wireless sensing service.

The first measurement result includes indication information indicating whether there is a line of sight.

According to a second aspect, a wireless communication method is provided, and the method includes: transmitting, by a target device, a wireless signal.

The wireless signal is used to obtain a first measurement result through measurement, the first measurement result includes indication information indicating whether there is a line of sight, and the first measurement result is used to determine whether to activate a wireless sensing service.

According to a third aspect, a wireless communication method is provided, and the method includes: obtaining, by a target device, a first measurement result by measuring a wireless signal, and transmitting, by the target device, the first measurement result.

The first measurement result is used to determine whether to activate a wireless sensing service.

According to a fourth aspect, a wireless communication method is provided, and the method includes: transmitting, by a sensing functional entity, first information.

The first information is used to indicate that a sensed target supports a wireless communication function, or the first information is used to indicate that a sensed target supports a wireless signal transmitting function, or the first information is used to indicate that a sensed target supports a function of measuring a received wireless signal; and the first information is used to trigger transmitting of a wireless signal, and/or the first information is used to trigger determining, based on a first measurement result, of whether to activate a wireless sensing service, where the first measurement result includes indication information indicating whether there is a line of sight.

According to a fifth aspect, a sensing device is provided and configured to execute the method in the first aspect.

Specifically, the sensing device includes a functional module configured to execute the method in the first aspect.

According to a sixth aspect, a target device is provided and configured to execute the method in the second aspect or the third aspect.

Specifically, the target device includes a functional module configured to execute the method in the second aspect or the third aspect.

According to a seventh aspect, a sensing functional entity is provided and configured to execute the method in the fourth aspect.

Specifically, the sensing functional entity includes a functional module configured to execute the method in the fourth aspect.

According to an eighth aspect, a sensing device is provided, including a processor and a memory. The memory is configured to store a computer program, and the processor is configured to invoke and run the computer program stored in the memory, to cause the sensing device to execute the method in the first aspect.

According to a ninth aspect, a target device is provided, including a processor and a memory. The memory is configured to store a computer program, and the processor is configured to invoke and run the computer program stored in the memory, to cause the target device to execute the method in the second aspect or the third aspect.

According to a tenth aspect, a sensing functional entity is provided, including a processor and a memory. The memory is configured to store a computer program, and the processor is configured to invoke and run the computer program stored in the memory, to cause the sensing functional entity to execute the method in the fourth aspect.

According to an eleventh aspect, an apparatus is provided and configured to implement the method in any one of the first aspect to the fourth aspect.

Specifically, the apparatus includes a processor, configured to invoke a computer program from a memory and run the computer program, to cause a device on which the apparatus is installed to execute the method in any one of the first aspect to the fourth aspect.

According to a twelfth aspect, a computer-readable storage medium is provided and configured to store a computer program. The computer program causes a computer to execute the method in any one of the first aspect to the fourth aspect.

According to a thirteenth aspect, a computer program product is provided, including computer program instructions. The computer program instructions cause a computer to execute the method in any one of the first aspect to the fourth aspect.

According to a fourteenth aspect, a computer program is provided. When the computer program runs on a computer, the computer executes the method in any one of the first aspect to the fourth aspect.

### BRIEF DESCRIPTION OF DRAWINGS

FIG. 1 is a schematic diagram of a communications system architecture to which an embodiment of this application is applied.

FIG. 2 is a schematic diagram of a network architecture to which an embodiment of this application is applied.

FIG. 3 is a flowchart of UE-level sensing according to this application.

FIG. 4 is a schematic flowchart of a wireless communication method according to an embodiment of this application.

FIG. 5 is a schematic diagram of determining whether to activate wireless sensing according to an embodiment of this application.

FIG. 6 is another schematic diagram of determining whether to activate wireless sensing according to an embodiment of this application.

FIG. 7 is a schematic flowchart of another wireless communication method according to an embodiment of this application.

FIG. 8 is a schematic flowchart of still another wireless communication method according to an embodiment of this application.

FIG. 9 is a schematic flowchart of yet another wireless communication method according to an embodiment of this application.

FIG. 10 is a schematic block diagram of a sensing device according to an embodiment of this application.

FIG. 11 is a schematic block diagram of a target device according to an embodiment of this application.

FIG. 12 is a schematic block diagram of another target device according to an embodiment of this application.

FIG. 13 is a schematic block diagram of a sensing functional entity according to an embodiment of this application.

FIG. 14 is a schematic block diagram of a communications device according to an embodiment of this application.

FIG. 15 is a schematic block diagram of an apparatus according to an embodiment of this application.

FIG. 16 is a schematic block diagram of a communications system according to an embodiment of this application.

### DESCRIPTION OF EMBODIMENTS

The following describes the technical solutions in embodiments of this application with reference to the accompanying drawings in embodiments of this application. Apparently, the described embodiments are some rather than all of embodiments of this application. For embodiments of this application, all other embodiments obtained by a person of ordinary skill in the art without creative efforts fall within the protection scope of this application.

The technical solutions in embodiments of this application may be applied to various communications systems, for example, a global system for mobile communications (GSM), a code division multiple access (CDMA) system, a wideband code division multiple access (WCDMA) system, a general packet radio service (GPRS), a long-term evolution (LTE) system, an advanced long-term evolution (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunications system (UMTS), a wireless local area network (WLAN), an internet of things (IoT), wireless fidelity (WiFi), a fifth-generation (5G) system, or another communications system.

Generally, the quantity of connections supported by a conventional communications system is limited and is also easy to implement. However, with development of communication technologies, a mobile communications system not only supports conventional communication, but also supports, for example, device-to-device (D2D) communication, machine to machine (M2M) communication, machine type communication (MTC), vehicle to vehicle (V2V) communication, or vehicle to everything (V2X) communication. Embodiments of this application may also be applied to these communications systems.

In some embodiments, the communications system in embodiments of this application may be applied to a carrier aggregation (CA) scenario, a dual connectivity (DC) scenario, a standalone (SA) networking scenario, or a non-standalone (NSA) networking scenario.

In some embodiments, the communications system in embodiments of this application may be applied to an unlicensed spectrum, and the unlicensed spectrum may also be considered as a shared spectrum. Alternatively, the communications system in embodiments of this application may be applied to a licensed spectrum, and the licensed spectrum may also be considered as a non-shared spectrum.

In some embodiments, the communications system in embodiments of this application may be applied to an FR1 frequency band (which corresponds to a frequency band range from 410 MHz to 7.125 GHZ), an FR2 frequency band (which corresponds to a frequency band range from 24.25 GHz to 52.6 GHZ), or a new frequency band, for example, a high frequency band corresponding to a frequency band range from 52.6 GHz to a 71 GHz or corresponding to a frequency band range from 71 GHz to 114.25 GHZ.

Embodiments of this application are described with reference to a network device and a terminal device. The terminal device may also be referred to as user equipment (UE), an access terminal, a subscriber unit, a user station, a mobile site, a mobile station, a remote station, a remote terminal, a mobile device, a user terminal, a terminal, a wireless communications device, a user agent, a user apparatus, or the like.

The terminal device may be a station (ST) in a WLAN, may be a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next-generation communications system such as an NR network, a terminal device in a future evolved public land mobile network (PLMN), or the like.

In embodiments of this application, the terminal device may be deployed on land, including being indoors or outdoors, handheld, wearable, or vehicle-mounted. The terminal device may also be deployed on water (for example, on a ship), or may be deployed in the air (for example, on an airplane, a balloon, or a satellite).

In embodiments of this application, the terminal device may be a mobile phone, a tablet computer (Pad), a computer with a wireless transceiver function, a virtual reality (VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device in smart home, a vehicle-mounted communications device, a wireless communication chip/application-specific integrated circuit (ASIC)/system on chip (SoC), or the like.

By way of example rather than limitation, in embodiments of this application, the terminal device may alternatively be a wearable device. The wearable device may also be referred to as a wearable smart device, and is a general term for wearable devices such as glasses, gloves, watches, clothes, and shoes that are intelligently designed and developed based on daily wearing by using a wearable technology. The wearable device is a portable device that can be directly worn or integrated into clothes or accessories of a user. In addition to being a hardware device, the wearable device can also realize various functions through software support, data interaction, and cloud interaction. In a broad sense, the wearable smart device includes a full-featured and large-sized device that can implement all or some functions without relying on a smartphone, for example, a smart watch or smart glasses, and a device that only focuses on a specific type of application function and needs to be used in cooperation with another device such as a smartphone, for example, various smart bracelets and smart jewelries for physical sign monitoring.

In embodiments of this application, the network device may be a device configured to communicate with a mobile device. The network device may be an access point (AP) in a WLAN, may be a base transceiver station (BTS) in GSM or CDMA, may be a NodeB (NB) in WCDMA, or may be an evolved NodeB (Evolutional Node B, eNB or eNodeB) in LTE, or a relay station or an access point, or a vehicle-mounted device, a wearable device, a network device or a gNodeB (gNB) in an NR network, or a network device in a future evolved PLMN, or a network device in an NTN, or the like.

By way of example rather than limitation, in embodiments of this application, the network device may have a mobility characteristic. For example, the network device may be a mobile device. In some embodiments, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. In some embodiments, the network device may alternatively be a base station disposed in a location such as land or water.

In embodiments of this application, the network device may provide a service for a cell. The terminal device communicates with the network device by using a transmission resource (for example, a frequency domain resource or a spectrum resource) used by the cell. The cell may be a cell corresponding to the network device (for example, a base station). The cell may belong to a macro base station or may belong to a base station corresponding to a small cell. The small cell herein may include a metro cell, a micro cell, a pico cell, a femto cell, or the like. These small cells have a characteristic of a small coverage range and low transmit power, and are applicable to providing a high-rate data transmission service.

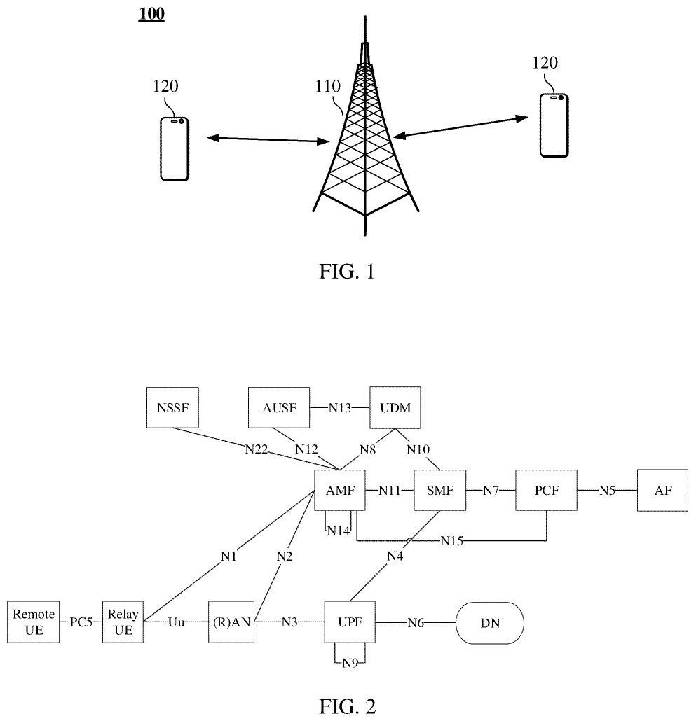

For example, a communications system 100 to which an embodiment of this application is applied is shown in FIG. 1. The communications system 100 may include a network device 110, and the network device 110 may be a device that communicates with a terminal device 120 (or referred to as a communication terminal or a terminal). The network device 110 may provide communication coverage in a specific geographic area, and may communicate with a terminal device located in the coverage area.

FIG. 1 shows one network device and two terminal devices as an example. In some embodiments, the communications system 100 may include a plurality of network devices, and another number of terminal devices may be included within a coverage range of each network device. This is not limited in embodiments of this application.

In some embodiments, the communications system 100 may further include another network entity such as a network controller or a mobility management entity. This is not limited in embodiments of this application.

It should be understood that a device having a communication function in a network/system in embodiments of this application may be referred to as a communications device. The communications system 100 shown in FIG. 1 is used as an example. The communications device may include the network device 110 and the terminal device 120 that have a communication function. The network device 110 and the terminal device 120 may be specific devices described above, and details are not described herein again. The communications device may further include another device in the communications system 100, for example, another network entity such as a network controller or a mobility management entity. This is not limited in embodiments of this application.

It should be understood that the terms “system” and “network” in this specification may often be used interchangeably in this specification. In this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

It should be understood that this specification relates to a first communications device and a second communications device. The first communications device may be a terminal device, for example, a mobile phone, a machine facility, customer premise equipment (CPE), an industrial device, or a vehicle. The second communications device may be a peer communications device of the first communications device, for example, a network device, a mobile phone, an industrial device, or a vehicle. In this specification, the first communications device is the terminal device and the second communications device is the network device as a specific instance for description.

The terms used in implementations of this application are only used to illustrate specific embodiments of this application, but are not intended to limit this application. The terms “first”, “second”, “third”, “fourth”, and the like in the specification, claims, and accompanying drawings of this application are used for distinguishing different objects from each other, rather than defining a specific order. In addition, the terms “include” and “have” and any variations thereof are intended to cover a non-exclusive inclusion.

It should be understood that, the “indication” mentioned in embodiments of this application may be a direct indication or an indirect indication, or indicate an association. For example, if A indicates B, it may mean that A directly indicates B, for example, B can be obtained from A. Alternatively, it may mean that A indicates B indirectly, for example, A indicates C, and B can be obtained from C. Alternatively, it may mean that there is an association between A and B.

In the description of embodiments of this application, the term “corresponding” may mean that there is a direct or indirect correspondence between two elements, or that there is an association between two elements, or that there is a relationship of “indicating” and “being indicated”, “configuring” and “being configured”, or the like.

In embodiments of this application, the “predefining” and “pre-configuration” may be implemented by pre-storing a corresponding code or table in a device (for example, including the terminal device and the network device) or in other manners that may be used for indicating related information. A specific implementation thereof is not limited in this application. For example, predefining may indicate being defined in a protocol.

In embodiments of this application, the “protocol” may indicate a standard protocol in the communication field, which may include, for example, an LTE protocol, an NR protocol, and a related protocol applied to a future communications system. This is not limited in this application.

To facilitate understanding of the technical solutions in embodiments of this application, the following describes the technical solutions in this application in detail by using specific embodiments. The following related technologies, as optional solutions, may be randomly combined with the technical solutions of embodiments of this application, all of which fall within the protection scope of embodiments of this application. Embodiments of this application include at least a part of the following content.

To facilitate understanding of the technical solutions in embodiments of this application, the following describes a network architecture in embodiments of this application.

FIG. 2 is a schematic diagram of a network architecture according to an embodiment of this application. As shown in FIG. 2, a 5G network architecture released by a 3rd generation partnership project (3GPP) standard organization includes: a terminal (UE), an access network (RAN, or AN) that supports 3GPP technologies, a user plane function (UPF) network element, an access and mobility management function (AMF) network element, a session management function (SMF) network element, a policy control function (PCF) network element, an application function (AF), a data network (DN), a network slice selection function (NSSF), an authentication server function (AUSF), and a unified data management (UDM) function.

A person skilled in the art should understand that the 5G network architecture shown in FIG. 2 does not constitute a limitation on the 5G network architecture. In specific implementation, the 5G network architecture may include more or fewer network elements than those shown in the figure, or some network elements may be combined, or the like. It should be understood that, in FIG. 2, R(AN) represents AN or RAN.

The terminal may be user equipment (UE), a handheld terminal, a notebook computer, a subscriber unit, a cellular phone, a smartphone, a wireless data card, a personal digital assistant (PDA) computer, a tablet computer, a wireless modem, a handheld device, a laptop computer, a cordless phone or wireless local loop (WLL) station, a machine type communication (MTC) terminal, a handheld device with a wireless communication function, a computing device, a processing device connected to a wireless modem, an unmanned aerial vehicle, a vehicle-mounted device, a wearable device, a terminal in an internet of things, a virtual reality device, a terminal device in a future 5G network, a terminal in a future evolved public land mobile network (PLMN), or the like.

The access network device is an access device for the terminal to access the network architecture in a wireless manner, and is mainly responsible for radio resource management, quality of service (QOS) management, data compression and encryption, and the like on an air interface side. For example, the access network device is a base station NodeB, an evolved base station eNodeB, a base station in a 5G mobile communications system or a new radio (NR) communications system, a base station in a future mobile communications system, or the like.

The UPF network element, the AMF network element, the SMF network element, and the PCF network element are network elements of a 3GPP core network (referred to as core network elements). The UPF network element may be referred to as a user plane function network element, which is mainly responsible for transmission of user data. Other network elements may be referred to as control plane function network elements, which are mainly responsible for authentication, authorization, registration management, session management, mobility management, policy control, and the like, to ensure reliable and stable transmission of user data.

The UPF network element may be used to forward and receive data of the terminal. For example, the UPF network element may receive service data from the data network and transmit the service data to the terminal through an access network device; and the UPF network element may further receive user data from the terminal through the access network device and forward the user data to the data network. A transmission resource allocated and scheduled by the UPF network element for the terminal is managed and controlled by the SMF network element. Bearers between the terminal and the UPF network element may include: a user plane connection between the UPF network element and the access network device, and a channel established between the access network device and the terminal. The user plane connection is a quality of service (QOS) flow established between the UPF network element and the access network device for data transmission.

The AMF network element may be used to manage access of the terminal to a core network, such as location update, network registration, and access control of the terminal, mobility management of the terminal, attachment and detachment of the terminal, and the like. While providing services for a session of the terminal, the AMF network element may further provide a control plane storage resource for the session, to store a session identifier, an SMF network element identifier associated with the session identifier, and the like.

The SMF network element may be used to select a user plane network element for the terminal, redirect a user plane network element for the terminal, allocate an internet protocol (IP) address to the terminal, establish a bearer (also referred to as a session) between the terminal and the UPF network element, modify and release a session, and perform QoS control.

The PCF network element is used to provide policies, such as QoS policies and slice selection policies, to the AMF network element and the SMF network element.

The AF network element is used to interact with a 3GPP core network element to support routing of application-affected data, access a network exposure function, interact with the PCF network element for policy control, and the like.

The DN may provide data services for an IP multi-media service (IMS) network, the internet, and the like for users. The DN may include a plurality of application servers (AS), providing different application services, such as operator services and internet access or third-party services. The AS may implement a function of the AF.

The NSSF is used to select a network slice and supports the following functions: selecting a set of network slice instances to serve UE; determining allowed network slice selection assistance information (NSSAI), and when necessary, determining a mapping to subscribed single-network slice selection assistance information (S-NSSAI); determining configured NSSAI, and when necessary, determining a mapping to subscribed S-NSSAI; and determining a set of AMFs that may be used to query UE, or determining a list of candidate AMFs based on a configuration.

The AUSF is used to receive a request from the AMF for authenticating the terminal, and perform authentication processing by requesting a key from the UDM and then forwarding a delivered key to the AMF.

The UDM includes functions such as generation and storage of user subscription data and management of authentication data, and supports interaction with an external third-party server.

Each network element in FIG. 2 may be a network element in a hardware device, a software function running on dedicated hardware, or a virtualized function instantiated on a platform (for example, a cloud platform). It should be noted that, in the network architecture shown in FIG. 2, network elements included in the entire network architecture are merely described as examples. In embodiments of this application, the network elements included in the entire network architecture are not limited.

To facilitate understanding of the technical solutions in embodiments of this application, the following describes wireless sensing in this application.

A cellular network (including a 5G network) is used for communication only. However, a wireless electromagnetic wave signal used in the cellular network not only can be used for wireless data transmission and communication, but also has an environment sensing capability, such as motion or gesture recognition and respiration monitoring of a user, measurement of a moving speed of a terminal, environment imaging, and weather monitoring. Therefore, a future cellular network may consider not only for communication and data transmission, but also for acquisition of sensing information.

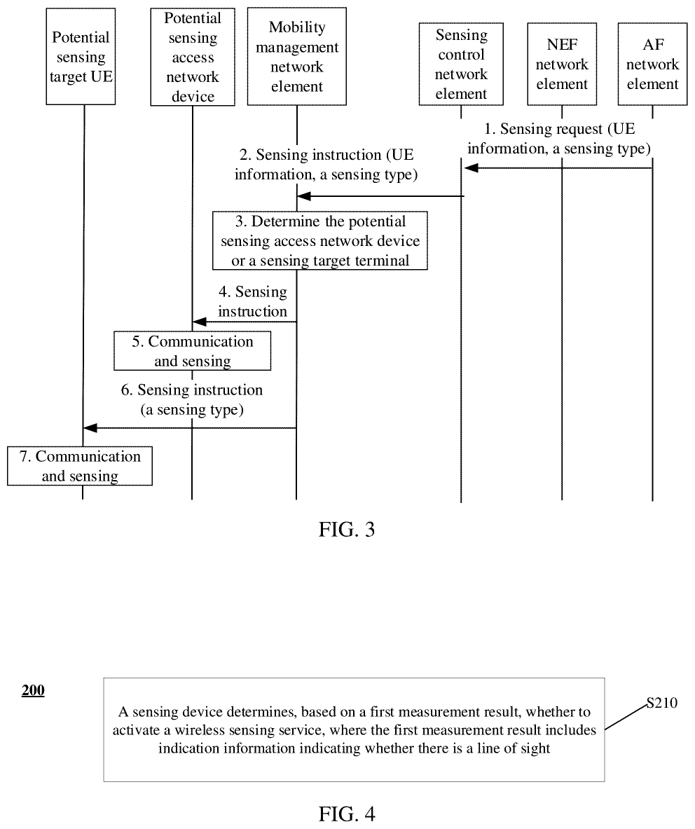

A sensing capability is supported in a beyond 5G (B5G) network, and a sensing function is supported in a 3GPP network by adding a sensing control network element (Sensing Function) and corresponding procedures. FIG. 3 is a possible flowchart of controlling an access network device or UE to perform a UE-level sensing operation. When an application function (AF) network element transmits a sensing request for a target UE/object to a core network of a 3GPP network by using a network exposure function (NEF) network element, the core network selects a correct access network device or auxiliary UE by using the sensing control network element or an AMF, triggers a capability of performing sensing-related wireless measurement, starts measurement of sensing information, and generates a sensing result.

In some embodiments, main wireless sensing scenarios of integrated sensing and communication are as follows:
1) Monostatic sensing link: A base station transmits a sensing signal and receives an echo signal.
2) Bistatic sensing link: A base station B receives a sensing signal transmitted by a base station A.
3) Air interface uplink sensing link: A base station receives a sensing signal transmitted by a terminal.
4) Air interface downlink sensing link: A terminal receives a sensing signal transmitted by a base station.
5) Terminal echo sensing link: A terminal transmits a sensing signal and receives an echo signal.
6) Inter-terminal sensing link: A terminal B receives a sensing signal transmitted by a terminal A.

In an initial stage of integrated sensing and communication of B5G, it is considered to perform a sensing action by reusing existing air interface signals as much as possible, without introducing excessive air interface enhancement.

To facilitate understanding of the technical solutions in embodiments of this application, the following describes a line of sight (LOS) or a non-line of sight (Non-Line of Sight, NLOS) in this application.

Line-of-sight propagation is an action of propagating electromagnetic rays along a straight line. Rays or waves, when encountering an obstacle, deviate from an original path or are reflected, and cannot continue to propagate along the horizon or bypass the obstacle. In a communications system, a receive end performs channel estimation on a received signal, and determines and identifies a NLOS/LOS propagation scenario by inputting a channel characteristic (such as a delay spread (DS), an angular spread (AS), a K factor, and a path loss) obtained through channel estimation to a specific mathematical model.

In some embodiments, when feeding back a measurement result, a terminal transmits, to a network, indication information indicating whether there is a LOS propagation path.

To facilitate understanding of the technical solutions in embodiments of this application, the following describes the problems solved in this application.

Wireless sensing can be performed only when there is a lightly occluded or even non-occluded line of sight channel between a sensing device and a target. How to determine whether there is a slightly occluded/non-occluded line of sight channel between a sensing device and a target is an urgent problem to be solved. In addition, before finding the target, the sensing device has to transmit a radio beam and sweep a large range to determine azimuth information of the target. This measure consumes relatively large power consumption and also takes a relatively long time.

Based on the foregoing technical problem, this application provides a sensing solution. A sensing device can learn, based on a measurement result, whether there is a line of sight. In this way, the sensing device can determine whether to activate a wireless sensing service. This helps improve accuracy of wireless sensing.

The following describes the technical solutions in this application in detail by using specific embodiments.

FIG. 4 is a schematic flowchart of a wireless communication method 200 according to an embodiment of this application. As shown in FIG. 4, the wireless communication method 200 may include at least part of the following content:

S210: A sensing device determines, based on a first measurement result, whether to activate a wireless sensing service, where the first measurement result includes indication information indicating whether there is a line of sight.

In some embodiments, a sensed target supports a wireless communication function, or a sensed target supports a wireless signal transmitting function, or a sensed target supports a function of measuring a received wireless signal. For example, the sensed target may be a terminal device.

In some embodiments, the sensed target may be a terminal device, and the sensing device may be a serving base station of the terminal device. Alternatively, the sensed target may be a terminal device, and the sensing device may be another terminal device.

It should be noted that the sensed target may also be referred to as a sensed device or a sensed object. This is not limited in this application.

In some embodiments, the first measurement result is obtained by the sensing device by measuring a wireless signal.

Specifically, for example, a sensing device obtains a first measurement result by measuring a wireless signal transmitted by a sensed target. In this case, indication information included in the first measurement result may indicate whether there is a line of sight between the sensing device and the sensed target.

Specifically, for another example, a sensing device obtains a first measurement result by measuring wireless signals transmitted by one or more devices around. In this case, indication information included in the first measurement result may indicate whether there is a line of sight around the sensing device. The one or more devices may include a sensed target, or may not include a sensed target.

In some embodiments, the first measurement result is obtained by the sensing device, and the first measurement result is obtained by measuring a wireless signal transmitted by the sensing device.

Specifically, for example, a sensed target obtains a first measurement result by measuring a wireless signal transmitted by a sensing device. In this case, indication information included in the first measurement result may indicate whether there is a line of sight between the sensing device and the sensed target.

Specifically, for another example, one or more devices around a sensing device obtain a first measurement result by measuring a wireless signal transmitted by the sensing device. In this case, indication information included in the first measurement result may indicate whether there is a line of sight around the sensing device. The one or more devices may include a sensed target, or may not include a sensed target.

In some embodiments, indication information included in the first measurement result may indicate whether there is a line of sight between a sensing device and a sensed target. In this case, the foregoing step S210 may specifically include the following steps. The sensing device determines, based on the first measurement result, whether to activate a wireless sensing service for the sensed target.

In some embodiments, the foregoing step S210 may specifically include: in a case that there is a line of sight, the sensing device determines to activate the wireless sensing service; and/or in a case that there is no line of sight, the sensing device determines not to activate the wireless sensing service.

Specifically, for example, in a case that there is a line of sight between a sensing device and a sensed target, the sensing device determines to activate the wireless sensing service for the sensed target; and/or in a case that there is no line of sight between a sensing device and a sensed target, the sensing device determines not to activate the wireless sensing service for the sensed target.

In some embodiments, the first measurement result further includes angle information. For example, the angle information may reflect an angle between a sensing device and a sensed target.

In some embodiments, the angle information includes but is not limited to at least one of the following: an angle of arrival (AoA), an azimuth, an angle of elevation, or an angle of departure (AoD).

In some embodiments, in a case that the first measurement result is obtained by the sensing device by measuring a wireless signal, the angle information includes but is not limited to at least one of the following: an angle of arrival (AoA), an azimuth, or an angle of elevation.

In some embodiments, in a case that the first measurement result is obtained by measuring a wireless signal transmitted by the sensing device, the angle information includes but is not limited to at least one of the following: an angle of departure (AoD), an azimuth, or an angle of elevation.

In some embodiments, in a case of determining to activate the wireless sensing service, the sensing device transmits a wireless signal based on the angle information. In this way, a process of locking a target through wireless sensing may be accelerated.

Specifically, for example, in a case that a sensing device determines to activate a wireless sensing service for a sensed target, the sensing device transmits a wireless signal to the sensed target based on the angle information.

In some embodiments, in a case of determining not to activate the wireless sensing service, the sensing device transmits first indication information. The first indication information is used to indicate that the sensing device rejects to activate or cannot activate wireless sensing.

Specifically, for example, in a case that a sensing device determines not to activate a wireless sensing service for a sensed target, the sensing device transmits first indication information to the sensed target. The first indication information is used to indicate that the sensing device rejects to activate or cannot activate wireless sensing for the sensed target.

In some embodiments, the first indication information includes a reason field. The reason field is used to indicate that a reason why the sensing device rejects to activate or cannot activate wireless sensing is that there is no line of sight.

In some embodiments, the sensing device receives first information. The first information is used to indicate that a sensed target supports a wireless communication function, or the first information is used to indicate that a sensed target supports a wireless signal transmitting function, or the first information is used to indicate that a sensed target supports a function of measuring a received wireless signal.

Specifically, for example, the sensing device receives the first information transmitted by a first core network device. For example, the first core network device is an AMF entity, or the first core network device is a sensing control network element, or the first core network device is a sensing functional entity.

In some embodiments, the first information includes but is not limited to at least one of the following: identity information of the sensed target, a cell radio network temporary identifier (C-RNTI) of the sensed target, a cell identity of a serving cell of the sensed target, or information of a serving base station of the sensed target.

In some embodiments, the first information is used to trigger determining, based on the first measurement result, of whether to activate a wireless sensing service.

In some embodiments, in a case that the first measurement result is obtained by the sensing device by measuring a wireless signal, a configuration of the wireless signal is indicated by the sensing device, or a configuration of the wireless signal is indicated by a serving base station of a sensed target.

Specifically, for example, in a case that the first measurement result is obtained by the sensing device by measuring a wireless signal transmitted by a sensed target, a configuration of the wireless signal is indicated by the sensing device to the sensed target, or a configuration of the wireless signal is indicated by a serving base station of the sensed target to the sensed target. In this case, the sensed target transmits the wireless signal based on configuration information indicated by the sensing device, or the sensed target transmits the wireless signal based on configuration information indicated by the serving base station of the sensed target.

In some embodiments, the sensing device transmits a configuration of the wireless signal. Specifically, for example, in a case that the first measurement result is obtained by measuring a wireless signal transmitted by the sensing device, the sensing device transmits a configuration of the wireless signal.

In some embodiments, a wireless signal transmitted by the sensing device carries a first reference signal; and/or a wireless signal measured by the sensing device carries a second reference signal.

Specifically, for example, the first reference signal is a positioning reference signal (PRS), and/or the second reference signal is a sounding reference signal (SRS). That is, a sensed target may obtain the first measurement result by measuring the PRS carried in the wireless signal transmitted by the sensing device. Alternatively, the sensing device may obtain the first measurement result by measuring the SRS carried in the wireless signal.

In addition, the first reference signal and the second reference signal may also be other reference signals. This is not limited in this application.

In some embodiments, indication information that is included in the first measurement result and that indicates whether there is a line of sight may be losNlosIndicator. A syntax element corresponding to losNlosIndicator may be shown below, and the losNlosIndicator field may indicate a best estimate of a possibility of a line of sight (LOS) by a device that generates the first measurement result. Either a hard estimate or a soft estimate may be reported, where n0 to n10 correspond to 0 to 10, respectively. The proportion coefficient is 0.1.

| | | |
|---|---|---|
| nr-losNlosIndicator-r17 | CHOICE { | |
| losnlos-hard-r17 | ENUMERATED {n0, n10}, | |
| losnlos-soft-r17 | INTEGER (0 .. 10), | |
| ... | | |
| } | | OPTIONAL, |
| ... | | |
| } | | |

Therefore, in embodiments of this application, a first measurement result includes indication information indicating whether there is a line of sight. In this way, a sensing device can determine, based on the first measurement result, whether to activate a wireless sensing service. This helps improve accuracy of wireless sensing.

The following describes the technical solutions in this application in detail by using Embodiment 1 and Embodiment 2.

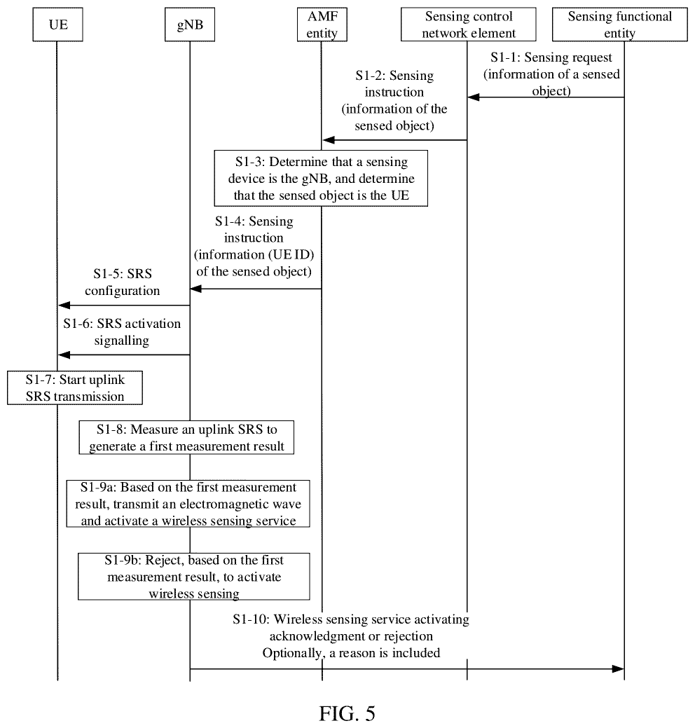

Embodiment 1: It is assumed that a sensing device is a gNB, and a sensed object is UE. Specifically, the gNB obtains a first measurement result by measuring an SRS transmitted by the UE, and may determine, by performing S1-1 to S1-11, whether to activate a wireless sensing service for the UE, as shown in FIG. 5.
S1-1: A sensing functional entity transmits a sensing request to a sensing control network element, where the sensing request includes information of the sensed object, and the information of the sensed object includes at least indication information indicating that the sensed object is configured with a wireless communication function. Optionally, the information of the sensed object further includes at least one of the following: identity (ID) information of the UE, a C-RNTI of the UE, a cell ID of a serving cell in which the UE is located, or information of a serving gNB of the UE.
S1-2: The sensing control network element forwards the sensing request to an AMF entity.
S1-3: The AMF entity determines that the sensing device is the gNB, and determines that the sensed object is the UE.
S1-4: The AMF entity transmits a sensing instruction to the gNB, where the sensing instruction includes the information of the sensed object.
S1-5: The gNB configures the SRS for the UE, or the gNB requests a serving base station of the UE to configure the SRS for the UE.
S1-6: The UE receives SRS activation signalling.
S1-7: After receiving the SRS activation signalling, the UE starts uplink SRS transmission.
S1-8: The gNB measures an uplink SRS transmitted by the UE to generate the first measurement result, where the first measurement result includes a UL AoA, an azimuth, an angle of elevation, and NLOS/LOS indication information.
S1-9a: The gNB, based on the first measurement result, transmits an electromagnetic wave and starts to activate the wireless sensing service for the UE. Optionally, the gNB activates the wireless sensing service for the UE only when a NLOS/LOS determining result meets a specific condition.
S1-9b: The gNB rejects, based on the first measurement result, to activate wireless sensing. Optionally, the gNB rejects to activate wireless sensing when a NLOS/LOS determining result does not meet a condition.
S1-10: The gNB returns, to a network, signalling that carries wireless sensing service activating acknowledgment or rejection information. Optionally, a rejection reason that is, NLOS is transmitted to the network.

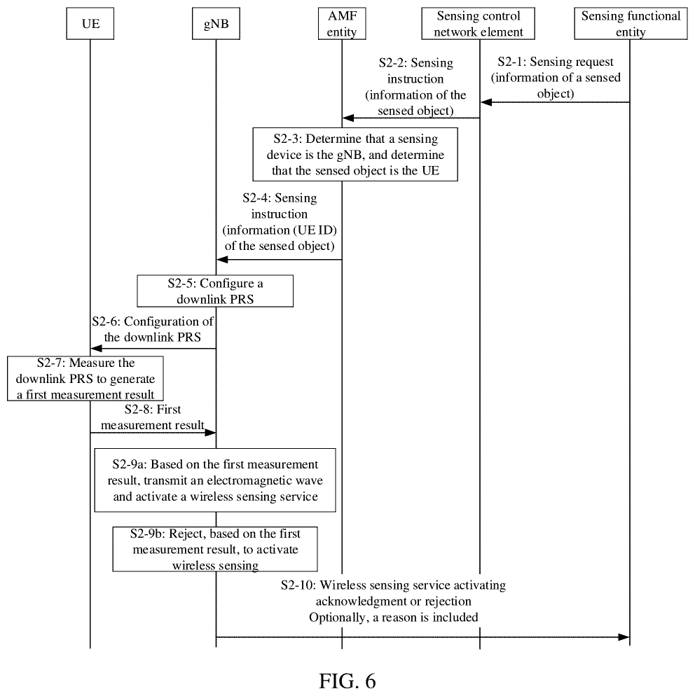

Embodiment 2: It is assumed that a sensing device is a gNB, and a sensed object is UE. Specifically, the UE obtains a first measurement result by measuring a PRS transmitted by the gNB, and may determine, by performing S2-1 to S2-11, whether to activate a wireless sensing service for the UE, as shown in FIG. 6.
S2-1: A sensing functional entity transmits a sensing request to a sensing control network element, where the sensing request includes information of the sensed object, and the information of the sensed object includes at least indication information indicating that the sensed object is configured with a wireless communication function. Optionally, the information of the sensed object further includes at least one of the following: ID information of the UE, a C-RNTI of the UE, a cell ID of a serving cell in which the UE is located, or information of a serving gNB of the UE.
S2-2: The sensing control network element forwards the sensing request to an AMF entity.
S2-3: The AMF entity determines that the sensing device is the gNB, and determines that the sensed object is the UE.
S2-4: The AMF entity transmits a sensing instruction to the gNB, where the sensing instruction includes the information of the sensed object.
S2-5: The gNB configures a DL-PRS for the UE.
S2-6: The UE receives a configuration of the DL-PRS.
S2-7: The UE measures the DL-PRS transmitted by the gNB to generate the first measurement result, where the first measurement result includes DL AoD, azimuth, elevation, and NLOS/LOS indication information.
S2-8: The UE transmits the first measurement result to the gNB.
S2-9a: The gNB, based on the first measurement result, transmits an electromagnetic wave and starts to activate the wireless sensing service for the UE. Optionally, the gNB activates the wireless sensing service for the UE only when a NLOS/LOS determining result meets a specific condition.
S2-9b: The gNB rejects, based on the first measurement result, to activate wireless sensing. Optionally, the gNB rejects to activate wireless sensing when a NLOS/LOS determining result does not meet a condition.
S2-10: The gNB returns, to a network, signalling that carries wireless sensing service activating acknowledgment or rejection information. Optionally, a rejection reason NLOS is transmitted to the network.

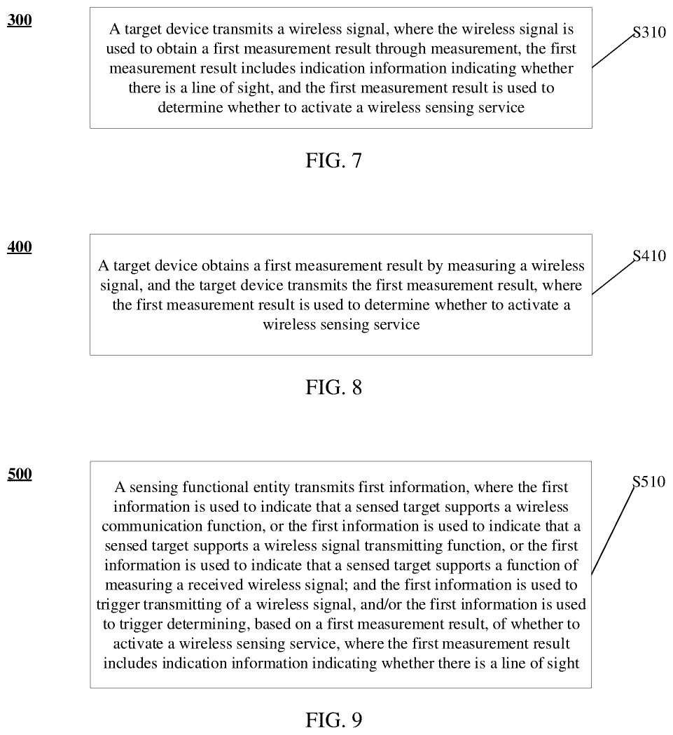

The foregoing describes in detail embodiments of a sensing device side in this application with reference to FIG. 4 to FIG. 6. The following describes in detail embodiments of a target device (which may be a sensed target) side in this application with reference to FIG. 7 and FIG. 8. It should be understood that the embodiments of the target device (which may be the sensed target) side correspond to the embodiments of the sensing device side. For similar descriptions, reference can be made to the embodiments of the sensing device side.

FIG. 7 is a schematic flowchart of a wireless communication method 300 according to an embodiment of this application. As shown in FIG. 7, the wireless communication method 300 may include at least part of the following content:

S310: A target device transmits a wireless signal, where the wireless signal is used to obtain a first measurement result through measurement, the first measurement result includes indication information indicating whether there is a line of sight, and the first measurement result is used to determine whether to activate a wireless sensing service.

In some embodiments, the wireless signal is measured by a sensing device to obtain a first measurement result. That is, the sensing device obtains the first measurement result by measuring the wireless signal transmitted by the target device.

In some embodiments, the target device is a sensed target. For example, the sensed target is a terminal device.

In some other embodiments, the target device may also be another device. This is not limited in this application.

In some embodiments, the target device supports a wireless communication function, or the target device supports a wireless signal transmitting function, or the target device supports a function of measuring a received wireless signal. For example, the target device may be a terminal device.

In some embodiments, the target device may be a terminal device, and a sensing device may be a serving base station of the terminal device. Alternatively, the target device may be a terminal device, and a sensing device may be another terminal device.

Specifically, for example, a target device obtains a first measurement result by measuring a wireless signal transmitted by a sensing device. In this case, indication information included in the first measurement result may indicate whether there is a line of sight between the sensing device and the target device.

In some embodiments, indication information included in the first measurement result may indicate whether there is a line of sight between a sensing device and a target device. In this case, the first measurement result is used by the sensing device to determine whether to activate the wireless sensing service for the target device.

In some embodiments, in a case that there is the line of sight, the first measurement result is used to determine to activate the wireless sensing service; and/or in a case that there is no line of sight, the first measurement result is used to determine not to activate the wireless sensing service.

Specifically, for example, in a case that there is a line of sight between a sensing device and a target device, the sensing device determines to activate the wireless sensing service for the target device; and/or in a case that there is no line of sight between a sensing device and a target device, the sensing device determines not to activate the wireless sensing service for the target device.

In some embodiments, the first measurement result further includes angle information. For example, the angle information may reflect an angle between a sensing device and a target device.

In some embodiments, the angle information includes but is not limited to at least one of the following: an AoA, an azimuth, an angle of elevation, or an AoD.

In some embodiments, the foregoing step S310 may specifically include the following step. The target device transmits the wireless signal based on a configuration of the wireless signal received.

In some embodiments, the wireless signal transmitted by the target device carries a second reference signal. In some embodiments, the second reference signal is an SRS. In addition, the second reference signal may also be another reference signal. This is not limited in this application.

Therefore, in embodiments of this application, a first measurement result may be obtained by measuring a wireless signal transmitted by a target device, and the first measurement result includes indication information indicating whether there is a line of sight. In this way, a sensing device can determine, based on the first measurement result, whether to activate a wireless sensing service. This helps improve accuracy of wireless sensing.

FIG. 8 is a schematic flowchart of a wireless communication method 400 according to an embodiment of this application. As shown in FIG. 8, the wireless communication method 400 may include at least part of the following content:

S410: A target device obtains a first measurement result by measuring a wireless signal, and the target device transmits the first measurement result, where the first measurement result is used to determine whether to activate a wireless sensing service.

In some embodiments, the target device obtains the first measurement result by measuring a wireless signal transmitted by a sensing device.

In some embodiments, the target device is a sensed target. For example, the sensed target is a terminal device.

In some other embodiments, the target device may also be another device. This is not limited in this application.

In some embodiments, the first measurement result includes indication information indicating whether there is a line of sight.

In some embodiments, the target device supports a wireless communication function, or the target device supports a wireless signal transmitting function, or the target device supports a function of measuring a received wireless signal. For example, the target device may be a terminal device.

In some embodiments, the target device may be a terminal device, and a sensing device may be a serving base station of the terminal device. Alternatively, the target device may be a terminal device, and a sensing device may be another terminal device.

In some embodiments, in a case that there is the line of sight, the first measurement result is used to determine to activate the wireless sensing service; and/or in a case that there is no line of sight, the first measurement result is used to determine not to activate the wireless sensing service.

Specifically, for example, in a case that there is a line of sight between a sensing device and a target device, the sensing device determines to activate the wireless sensing service for the target device; and/or in a case that there is no line of sight between a sensing device and a target device, the sensing device determines not to activate the wireless sensing service for the target device.

In some embodiments, the first measurement result further includes angle information. For example, the angle information may reflect an angle between a sensing device and a target device.

In some embodiments, the angle information includes but is not limited to at least one of the following: an AoD, an azimuth, an angle of elevation, or an AoA.

In some embodiments, the wireless signal carries a first reference signal. In some embodiments, the first reference signal is a PRS. In addition, the first reference signal may also be another reference signal. This is not limited in this application.

Therefore, in embodiments of this application, a target device may obtain a first measurement result by measuring a wireless signal, and the first measurement result includes indication information indicating whether there is a line of sight. In this way, a sensing device can determine, based on the first measurement result, whether to activate a wireless sensing service. This helps improve accuracy of wireless sensing.

The foregoing describes in detail embodiments of a sensing device side in this application with reference to FIG. 4 to FIG. 6. The following describes in detail embodiments of a sensing functional entity side in this application with reference to FIG. 9. It should be understood that the embodiments of the sensing functional entity side correspond to the embodiments of the sensing device side. For similar descriptions, reference can be made to the embodiments of the sensing device side.

FIG. 9 is a schematic flowchart of a wireless communication method 500 according to an embodiment of this application. As shown in FIG. 9, the wireless communication method 500 may include at least part of the following content:

S510: A sensing functional entity transmits first information, where the first information is used to indicate that a sensed target supports a wireless communication function, or the first information is used to indicate that a sensed target supports a wireless signal transmitting function, or the first information is used to indicate that a sensed target supports a function of measuring a received wireless signal; and the first information is used to trigger transmitting of a wireless signal, and/or the first information is used to trigger determining, based on a first measurement result, of whether to activate a wireless sensing service, where the first measurement result includes indication information indicating whether there is a line of sight.

In some embodiments, a sensed target supports a wireless communication function, or a sensed target supports a wireless signal transmitting function, or a sensed target supports a function of measuring a received wireless signal. For example, the sensed target may be a terminal device.

In some embodiments, the sensed target may be a terminal device, and the sensing device may be a serving base station of the terminal device. Alternatively, the sensed target may be a terminal device, and the sensing device may be another terminal device.

It should be noted that the sensed target may also be referred to as a sensed device or a sensed object. This is not limited in this application.

In some embodiments, the first measurement result is obtained by measuring a wireless signal.

For example, a sensing device obtains the first measurement result by measuring a wireless signal transmitted by a sensed target.

For another example, a sensed target obtains the first measurement result by measuring a wireless signal transmitted by a sensing device.

In some embodiments, the first information includes but is not limited to at least one of the following: identity information of the sensed target, a C-RNTI of the sensed target, a cell identity of a serving cell of the sensed target, or information of a serving base station of the sensed target.

In some embodiments, indication information included in the first measurement result may indicate whether there is a line of sight between a sensing device and a sensed target.

In some embodiments, in a case that there is the line of sight, the first measurement result is used to determine to activate the wireless sensing service; and/or in a case that there is no line of sight, the first measurement result is used to determine not to activate the wireless sensing service.

Specifically, for example, in a case that there is a line of sight between a sensing device and a target device, the sensing device determines to activate the wireless sensing service for the target device; and/or in a case that there is no line of sight between a sensing device and a target device, the sensing device determines not to activate the wireless sensing service for the target device.

In some embodiments, the first measurement result further includes angle information.

For example, the angle information may reflect an angle between a sensing device and a sensed target.

In some embodiments, the angle information includes but is not limited to at least one of the following: an AoA, an AoD, an azimuth, or an angle of elevation.

In some embodiments, in a case that the first measurement result is obtained by the sensing device by measuring a wireless signal, the angle information includes but is not limited to at least one of the following: an angle of arrival (AoA), an azimuth, or an angle of elevation. In some embodiments, in a case that the first measurement result is obtained by measuring a wireless signal transmitted by the sensing device, the angle information includes but is not limited to at least one of the following: an angle of departure (AoD), an azimuth, or an elevation.

In some embodiments, in a case of determining to activate the wireless sensing service, the sensing device transmits a wireless signal based on the angle information. In this way, a process of locking a target through wireless sensing may be accelerated.

Specifically, for example, in a case that a sensing device determines to activate a wireless sensing service for a sensed target, the sensing device transmits a wireless signal to the sensed target based on the angle information.

In some embodiments, in a case of determining not to activate the wireless sensing service, the sensing functional entity receives first indication information. The first indication information is used to indicate that wireless sensing is rejected to be activated or cannot be activated. Specifically, for example, the sensing functional entity receives the first indication information transmitted by a sensing device by using an AMF entity.

In some embodiments, the first indication information includes a reason field. The reason field is used to indicate a reason why wireless sensing is rejected to be activated or cannot be activated. Optionally, the reason includes that there is no line of sight or the sensed target is not reachable.

In some embodiments, a configuration of the wireless signal is indicated by a sensing device, or a configuration of the wireless signal is indicated by a serving base station of the sensed target.

In some embodiments, the wireless signal carries a first reference signal or a second reference signal. In some embodiments, the first reference signal is a PRS, and/or the second reference signal is an SRS. That is, a sensed target may obtain the first measurement result by measuring the PRS carried in the wireless signal transmitted by the sensing device. Alternatively, the sensing device may obtain the first measurement result by measuring the SRS carried in the wireless signal.

In addition, the first reference signal and the second reference signal may also be other reference signals. This is not limited in this application.

Therefore, in embodiments of this application, a sensing functional entity transmits first information. The first information is used to indicate that a sensed target supports a wireless communication function, or the first information is used to indicate that a sensed target supports a wireless signal transmitting function, or the first information is used to indicate that a sensed target supports a function of measuring a received wireless signal; and the first information is used to trigger determining, based on a first measurement result, of whether to activate a wireless sensing service, where the first measurement result includes indication information indicating whether there is a line of sight. In this way, a sensing device can determine, based on the first measurement result, whether to activate the wireless sensing service. This helps improve accuracy of wireless sensing.

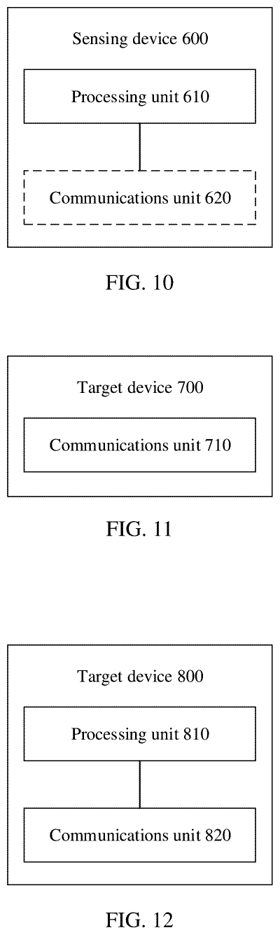

The foregoing describes in detail method embodiments of this application with reference to FIG. 4 to FIG. 9. The following describes in detail apparatus embodiments of this application with reference to FIG. 10 to FIG. 13. It should be understood that the apparatus embodiments correspond to the method embodiments. For similar descriptions, reference can be made to the method embodiments.

FIG. 10 is a schematic block diagram of a sensing device 600 according to an embodiment of this application. As shown in FIG. 10, the sensing device 600 includes: a processing unit 610, configured to determine, based on a first measurement result, whether to activate a wireless sensing service.

The first measurement result includes indication information indicating whether there is a line of sight.

In some embodiments, the first measurement result is obtained by the sensing device by measuring a wireless signal; or the first measurement result is obtained by the sensing device, and the first measurement result is obtained by measuring a wireless signal transmitted by the sensing device.

In some embodiments, the processing unit 610 is specifically configured to: in a case that there is a line of sight, determine to activate the wireless sensing service; and/or in a case that there is no line of sight, determine not to activate the wireless sensing service.

In some embodiments, the first measurement result further includes angle information.

In some embodiments, the angle information includes at least one of the following: an angle of arrival AoA, an azimuth, an angle of elevation, or an angle of departure AoD. In some embodiments, in a case that the first measurement result is obtained by the sensing device by measuring a wireless signal, the angle information includes at least one of the following: an angle of arrival AoA, an azimuth, or an angle of elevation; or in a case that the first measurement result is obtained by measuring a wireless signal transmitted by the sensing device, the angle information includes at least one of the following: an angle of departure AoD, an azimuth, or an angle of elevation.

In some embodiments, in a case of determining to activate the wireless sensing service, the sensing device 600 further includes: a communications unit 620, configured to transmit a wireless signal based on the angle information.

In some embodiments, in a case of determining not to activate the wireless sensing service, the sensing device 600 further includes: a communications unit 620, configured to transmit first indication information, where the first indication information is used to indicate that the sensing device rejects to activate or cannot activate wireless sensing.

In some embodiments, the first indication information includes a reason field. The reason field is used to indicate that a reason why the sensing device rejects to activate or cannot activate wireless sensing.

In some embodiments, the reason includes that there is no line of sight or a sensed target is not reachable.

In some embodiments, the sensing device 600 further includes: a communications unit 620, configured to receive first information.

The first information is used to indicate that a sensed target supports a wireless communication function, or the first information is used to indicate that a sensed target supports a wireless signal transmitting function, or the first information is used to indicate that a sensed target supports a function of measuring a received wireless signal.

In some embodiments, the first information includes at least one of the following: identity information of the sensed target, a cell radio network temporary identifier C-RNTI of the sensed target, a cell identity of a serving cell of the sensed target, or information of a serving base station of the sensed target.

In some embodiments, in a case that the first measurement result is obtained by the sensing device by measuring a wireless signal, a configuration of the wireless signal is indicated by the sensing device, or a configuration of the wireless signal is indicated by a serving base station of a sensed target.

In some embodiments, the sensing device 600 further includes: a communications unit 620, configured to transmit a configuration of the wireless signal.

In some embodiments, a wireless signal transmitted by the sensing device carries a first reference signal; and/or a wireless signal measured by the sensing device carries a second reference signal.

In some embodiments, the first reference signal is a positioning reference signal PRS, and/or the second reference signal is a sounding reference signal SRS.

In some embodiments, a sensed target is a terminal device.

In some embodiments, the communications unit may be a communications interface or a transceiver, or an input/output interface of a communications chip or a system on chip. The processing unit may be one or more processors.

It should be understood that the sensing device 600 according to embodiments of this application may correspond to the sensing device in method embodiments of this application, and the foregoing and other operations and/or functions of units in the sensing device 600 are respectively used to implement corresponding procedures of the sensing device in the method 200 shown in FIG. 4. For brevity, details are not described herein again.

FIG. 11 is a schematic block diagram of a target device 700 according to an embodiment of this application. As shown in FIG. 11, the target device 700 includes: a communications unit 710, configured to transmit a wireless signal.

The wireless signal is used to obtain a first measurement result through measurement, the first measurement result includes indication information indicating whether there is a line of sight, and the first measurement result is used to determine whether to activate a wireless sensing service.

In some embodiments, in a case that there is the line of sight, the first measurement result is used to determine to activate the wireless sensing service; and/or in a case that there is no line of sight, the first measurement result is used to determine not to activate the wireless sensing service.

In some embodiments, the first measurement result further includes angle information.

In some embodiments, the angle information includes at least one of the following: an angle of arrival AoA, an azimuth, an angle of elevation, or an angle of departure AoD.

In some embodiments, the communications unit 710 is specifically configured to: transmit the wireless signal based on a configuration of the wireless signal received.

In some embodiments, the wireless signal transmitted by the target device carries a second reference signal.

In some embodiments, the second reference signal is a sounding reference signal SRS.

In some embodiments, a sensed target is a terminal device.

In some embodiments, the communications unit may be a communications interface or a transceiver, or an input/output interface of a communications chip or a system on chip.

It should be understood that the target device 700 according to embodiments of this application may correspond to the target device in method embodiments of this application, and the foregoing and other operations and/or functions of units in the target device 700 are respectively used to implement corresponding procedures of the target device in the method 300 shown in FIG. 7. For brevity, details are not described herein again.

FIG. 12 is a schematic block diagram of a target device 800 according to an embodiment of this application. As shown in FIG. 12, the target device 800 includes: a processing unit 810, configured to obtain a first measurement result by measuring a wireless signal; and a communications unit 820, configured to transmit the first measurement result.

The first measurement result is used to determine whether to activate a wireless sensing service.

In some embodiments, the first measurement result includes indication information indicating whether there is a line of sight.

In some embodiments, in a case that there is the line of sight, the first measurement result is used to determine to activate the wireless sensing service; and/or in a case that there is no line of sight, the first measurement result is used to determine not to activate the wireless sensing service.

In some embodiments, the first measurement result further includes angle information.

In some embodiments, the angle information includes at least one of the following: an angle of departure AoD, an azimuth, an angle of elevation, or an angle of arrival AoA.

In some embodiments, the wireless signal carries a first reference signal.

In some embodiments, the first reference signal is a positioning reference signal PRS.

In some embodiments, a sensed target is a terminal device.

In some embodiments, the communications unit may be a communications interface or a transceiver, or an input/output interface of a communications chip or a system on chip. The processing unit may be one or more processors.

It should be understood that the target device 800 according to embodiments of this application may correspond to the target device in method embodiments of this application, and the foregoing and other operations and/or functions of units in the target device 800 are respectively used to implement corresponding procedures of the target device in the method 400 shown in FIG. 8. For brevity, details are not described herein again.

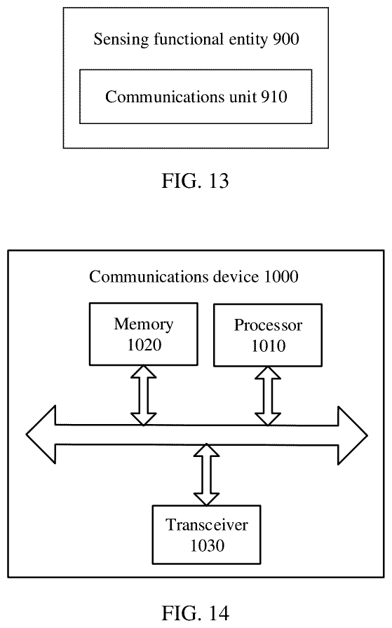

FIG. 13 is a schematic block diagram of a sensing functional entity 900 according to an embodiment of this application. As shown in FIG. 13, the sensing functional entity 900 includes: a communications unit 910, configured to transmit first information.

The first information is used to indicate that a sensed target supports a wireless communication function, or the first information is used to indicate that a sensed target supports a wireless signal transmitting function, or the first information is used to indicate that a sensed target supports a function of measuring a received wireless signal; and the first information is used to trigger transmitting of a wireless signal, and/or the first information is used to trigger determining, based on a first measurement result, of whether to activate a wireless sensing service, where the first measurement result includes indication information indicating whether there is a line of sight.

In some embodiments, the first measurement result is obtained by measuring a wireless signal.

In some embodiments, the first information includes at least one of the following: identity information of the sensed target, a cell radio network temporary identifier C-RNTI of the sensed target, a cell identity of a serving cell of the sensed target, or information of a serving base station of the sensed target.

In some embodiments, in a case that there is the line of sight, the first measurement result is used to determine to activate the wireless sensing service; and/or in a case that there is no line of sight, the first measurement result is used to determine not to activate the wireless sensing service.

In some embodiments, the first measurement result further includes angle information.

In some embodiments, the angle information includes at least one of the following: an angle of arrival AoA, an angle of departure AoD, an azimuth, or an angle of elevation.

In some embodiments, in a case of determining not to activate the wireless sensing service, the communications unit 910 is further configured to receive first indication information. The first indication information is used to indicate that wireless sensing is rejected to be activated or cannot be activated.

In some embodiments, the first indication information includes a reason field. The reason field is used to indicate a reason why wireless sensing is rejected to be activated or cannot be activated.

In some embodiments, the reason includes that there is no line of sight or the sensed target is not reachable.

In some embodiments, a configuration of the wireless signal is indicated by a sensing device, or a configuration of the wireless signal is indicated by a serving base station of the sensed target.

In some embodiments, the wireless signal carries a first reference signal or a second reference signal.

In some embodiments, the first reference signal is a positioning reference signal PRS, and/or the second reference signal is a sounding reference signal SRS.

In some embodiments, the sensed target is a terminal device.

In some embodiments, the communications unit may be a communications interface or a transceiver, or an input/output interface of a communications chip or a system on chip.

It should be understood that the sensing functional entity 900 according to embodiments of this application may correspond to the sensing functional entity in method embodiments of this application, and the foregoing and other operations and/or functions of units in the sensing functional entity 900 are respectively used to implement corresponding procedures of the sensing functional entity in the method 500 shown in FIG. 9. For brevity, details are not described herein again.

FIG. 14 is a schematic structural diagram of a communications device 1000 according to an embodiment of this application. The communications device 1000 shown in FIG. 14 includes a processor 1010, and the processor 1010 may invoke a computer program from a memory and run the computer program to implement a method in embodiments of this application.

In some embodiments, as shown in FIG. 14, the communications device 1000 may further include a memory 1020. The processor 1010 may invoke a computer program from the memory 1020 and run the computer program to implement a method in embodiments of this application.

The memory 1020 may be a separate component independent of the processor 1010, or may be integrated into the processor 1010.

In some embodiments, as shown in FIG. 14, the communications device 1000 may further include a transceiver 1030. The processor 1010 may control the transceiver 1030 to communicate with another device, and specifically, may transmit information or data to the another device, or receive information or data transmitted by the another device.

The transceiver 1030 may include a transmitting set and a receiving set. The transceiver 1030 may further include an antenna, and there may be one or more antennas.

In some embodiments, specifically, the communications device 1000 may be the sensing device in embodiments of this application, and the communications device 1000 may implement corresponding procedures implemented by the sensing device in methods in the embodiments of this application. For brevity, details are not described herein again.

In some embodiments, specifically, the communications device 1000 may be the target device in embodiments of this application, and the communications device 1000 may implement corresponding procedures implemented by the target device in methods in the embodiments of this application. For brevity, details are not described herein again.

In some embodiments, specifically, the communications device 1000 may be the sensing functional entity in embodiments of this application, and the communications device 1000 may implement corresponding procedures implemented by the sensing functional entity in methods in the embodiments of this application. For brevity, details are not described herein again.

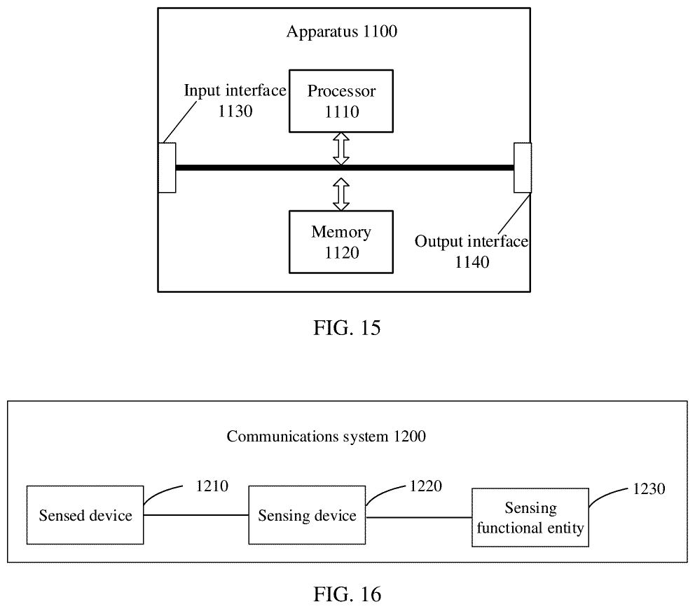

FIG. 15 is a schematic structural diagram of an apparatus according to an embodiment of this application. The apparatus 1100 shown in FIG. 15 includes a processor 1110, and the processor 1110 may invoke a computer program from a memory and run the computer program to implement a method in embodiments of this application.

In some embodiments, as shown in FIG. 15, the apparatus 1100 may further include a memory 1120. The processor 1110 may invoke a computer program from the memory 1120 and run the computer program to implement a method in embodiments of this application.

The memory 1120 may be a separate component independent of the processor 1110, or may be integrated into the processor 1110.

In some embodiments, the apparatus 1100 may further include an input interface 1130. The processor 1110 may control the input interface 1130 to communicate with another device or chip, and specifically, may obtain information or data transmitted by the another device or chip.

In some embodiments, the apparatus 1100 may further include an output interface 1140. The processor 1110 may control the output interface 1140 to communicate with another device or chip, and specifically, may output information or data to the another device or chip.

In some embodiments, the apparatus may be applied to the sensing device in embodiments of this application, and the apparatus may implement corresponding procedures implemented by the sensing device in methods in the embodiments of this application. For brevity, details are not described herein again.

In some embodiments, the apparatus may be applied to the target device in embodiments of this application, and the apparatus may implement corresponding procedures implemented by the target device in methods in the embodiments of this application. For brevity, details are not described herein again.

In some embodiments, the apparatus may be applied to the sensing functional entity in embodiments of this application, and the apparatus may implement corresponding procedures implemented by the sensing functional entity in methods in the embodiments of this application. For brevity, details are not described herein again.

In some embodiments, the apparatus mentioned in embodiments of this application may alternatively be a chip, for example, may be a system-level chip, a system chip, a chip system, a system-on-chip, or the like.

FIG. 16 is a schematic block diagram of a communications system 1200 according to an embodiment of this application. As shown in FIG. 16, the communications system 1200 includes a sensed device 1210, a sensing device 1220, and a sensing functional entity 1230. The sensed device 1210 may be configured to implement corresponding functions implemented by the sensed device in the foregoing method, the sensing device 1220 may be configured to implement corresponding functions implemented by the sensing device in the foregoing method, and the sensing functional entity 1230 may be configured to implement corresponding functions implemented by the sensing functional entity in the foregoing method. For brevity, details are not described herein again.

It should be understood that, a processor in embodiments of this application may be an integrated circuit chip having a signal processing capability. In an implementation process, the steps in the foregoing method embodiments may be performed by using an integrated logic circuit of hardware of the processor or instructions in a software form. The processor may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor may implement or execute the methods, steps, and logical block diagrams disclosed in embodiments of this application. The general-purpose processor may be a microprocessor, or the processor may be any conventional processor or the like. The steps of the methods disclosed with reference to embodiments of this application may be directly implemented by a hardware decoding processor, or may be implemented by a combination of hardware and software modules in a decoding processor. The software module may be located in a mature storage medium in the art, for example, a random access memory, a flash memory, a read-only memory, a programmable read-only memory, an erasable programmable memory, or a register. The storage medium is located in a memory. The processor reads information from the memory, and completes the steps of the foregoing methods in combination with hardware in the processor.

It may be understood that the memory in embodiments of this application may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (Electrically EPROM, EEPROM), or a flash memory. The volatile memory may be a random access memory (RAM), and is used as an external cache. By way of example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DR RAM). It should be noted that, the memory in the systems and methods described in this specification includes but is not limited to these memories and any memory of another proper type.

It should be understood that, by way of example but not limitative description, for example, the memory in embodiments of this application may alternatively be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synch link DRAM, SLDRAM), a direct Rambus random access memory (Direct Rambus RAM, DR RAM), or the like. In other words, the memory in embodiments of this application includes but is not limited to these memories and any memory of another proper type.

An embodiment of this application further provides a computer-readable storage medium, configured to store a computer program.

In some embodiments, the computer-readable storage medium may be applied to the sensing device in embodiments of this application, and the computer program causes a computer to execute corresponding procedures implemented by the sensing device in methods in the embodiments of this application. For brevity, details are not described herein again.

In some embodiments, the computer-readable storage medium may be applied to the target device in embodiments of this application, and the computer program causes a computer to execute corresponding procedures implemented by the target device in methods in the embodiments of this application. For brevity, details are not described herein again.

In some embodiments, the computer-readable storage medium may be applied to the sensing functional entity in embodiments of this application, and the computer program causes a computer to execute corresponding procedures implemented by the sensing functional entity in methods in the embodiments of this application. For brevity, details are not described herein again.

An embodiment of this application further provides a computer program product, including computer program instructions.

In some embodiments, the computer program product may be applied to the sensing device in embodiments of this application, and the computer program instructions cause a computer to execute corresponding procedures implemented by the sensing device in methods in the embodiments of this application. For brevity, details are not described herein again.

In some embodiments, the computer program product may be applied to the target device in embodiments of this application, and the computer program instructions cause a computer to execute corresponding procedures implemented by the target device in methods in the embodiments of this application. For brevity, details are not described herein again.

In some embodiments, the computer program product may be applied to the sensing functional entity in embodiments of this application, and the computer program instructions cause a computer to execute corresponding procedures implemented by the sensing functional entity in methods in the embodiments of this application. For brevity, details are not described herein again.

An embodiment of this application further provides a computer program.

In some embodiments, the computer program may be applied to the sensing device in embodiments of this application. When the computer program runs on a computer, the computer executes corresponding procedures implemented by the sensing device in methods in the embodiments of this application. For brevity, details are not described herein again.

In some embodiments, the computer program may be applied to the target device in embodiments of this application. When the computer program runs on a computer, the computer executes corresponding procedures implemented by the target device in methods in the embodiments of this application. For brevity, details are not described herein again.

In some embodiments, the computer program may be applied to the sensing functional entity in embodiments of this application. When the computer program runs on a computer, the computer executes corresponding procedures implemented by the sensing functional entity in methods in the embodiments of this application. For brevity, details are not described herein again.

A person of ordinary skill in the art may be aware that, units and algorithm steps in examples described in combination with embodiments disclosed in this specification can be implemented by electronic hardware or a combination of computer software and electronic hardware. Whether the functions are executed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, reference can be made to corresponding processes in the foregoing method embodiments. Details are not described herein again.

In several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objective of the solutions of the embodiments.

In addition, functional units in embodiments of this application may be integrated into one processing unit, or each of the units may exist alone physically, or two or more units may be integrated into one unit.

When the functions are implemented in a form of a software functional unit and sold or used as an independent product, the functions may be stored in a computer-readable storage medium. Based on such an understanding, the technical solutions in this application essentially, or the part contributing to the conventional technology, or some of the technical solutions may be implemented in a form of a software product. The computer software product is stored in a storage medium and includes several instructions for instructing a computer device (which may be a personal computer, a server, a network device, or the like) to execute all or some of the steps of the methods described in embodiments of this application. The foregoing storage medium includes various media that may store a program code, such as a USB flash drive, a removable hard disk, a read-only memory (ROM), a random access memory (RAM), a magnetic disk, or an optical disk.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application should be subject to the protection scope of the claims.

What is claimed is:

1. A sensing device, comprising a processor and a memory, wherein the memory is configured to store a computer program, and the processor is configured to invoke and run the computer program stored in the memory, to cause the sensing device to perform:
determining, based on a first measurement result, whether to activate a wireless sensing service, wherein
the first measurement result comprises indication information indicating whether there is a line of sight.

2. The sensing device according to claim 1, wherein
the first measurement result is obtained by the sensing device by measuring a wireless signal; or
the first measurement result is obtained by the sensing device, and the first measurement result is obtained by measuring a wireless signal transmitted by the sensing device.

3. The sensing device according to claim 1, wherein the determining, based on a first measurement result, whether to activate a wireless sensing service comprises:
in a case that there is a line of sight, determining to activate the wireless sensing service; and/or
in a case that there is no line of sight, determining not to activate the wireless sensing service.

4. The sensing device according to claim 1, wherein in a case of determining not to activate the wireless sensing service, the processor is configured to invoke and run the computer program stored in the memory, to cause the sensing device to further perform:
transmitting first indication information, wherein the first indication information is used to indicate that the sensing device rejects to activate or cannot activate wireless sensing.

5. The sensing device according to claim 4, wherein the first indication information comprises a reason field, and the reason field is used to indicate a reason why the sensing device rejects to activate or cannot activate wireless sensing.

6. The sensing device according to claim 5, wherein the reason comprises that there is no line of sight or a sensed target is not reachable.

7. The sensing device according to claim 1, wherein the processor is configured to invoke and run the computer program stored in the memory, to cause the sensing device to further perform:
receiving first information, wherein the first information is used to indicate that a sensed target supports a wireless communication function, or the first information is used to indicate that a sensed target supports a wireless signal transmitting function, or the first information is used to indicate that a sensed target supports a function of measuring a received wireless signal.

8. The sensing device according to claim 7, wherein the first information comprises at least one of the following: identity information of the sensed target, a cell radio network temporary identifier C-RNTI of the sensed target, a cell identity of a serving cell of the sensed target, or information of a serving base station of the sensed target.

9. The sensing device according to claim 1, wherein in a case that the first measurement result is obtained by the sensing device by measuring a wireless signal, a configuration of the wireless signal is indicated by the sensing device, or a configuration of the wireless signal is indicated by a serving base station of a sensed target.

10. A target device, comprising a processor and a memory, wherein the memory is configured to store a computer program, and the processor is configured to invoke and run the computer program stored in the memory, to cause the target device to perform:
obtaining a first measurement result by measuring a wireless signal, and transmitting the first measurement result, wherein
the first measurement result is used to determine whether to activate a wireless sensing service.

11. The target device according to claim 10, wherein the first measurement result comprises indication information indicating whether there is a line of sight.

12. The target device according to claim 11, wherein
in a case that there is the line of sight, the first measurement result is used to determine to activate the wireless sensing service; and/or
in a case that there is no line of sight, the first measurement result is used to determine not to activate the wireless sensing service.

13. A sensing functional entity, comprising a processor and a memory, wherein the memory is configured to store a computer program, and the processor is configured to invoke and run the computer program stored in the memory, to cause the sensing functional entity to perform:
transmitting first information, wherein
the first information is used to indicate that a sensed target supports a wireless communication function, or the first information is used to indicate that a sensed target supports a wireless signal transmitting function, or the first information is used to indicate that a sensed target supports a function of measuring a received wireless signal; and the first information is used to trigger transmitting of a wireless signal, and/or the first information is used to trigger determining, based on a first measurement result, of whether to activate a wireless sensing service, wherein the first measurement result comprises indication information indicating whether there is a line of sight.

14. The sensing functional entity according to claim 13, wherein the first measurement result is obtained by measuring the wireless signal.

15. The sensing functional entity according to claim 13, wherein the first information comprises at least one of the following: identity information of the sensed target, a cell radio network temporary identifier C-RNTI of the sensed target, a cell identity of a serving cell of the sensed target, or information of a serving base station of the sensed target.

16. The sensing functional entity according to claim 13, wherein
in a case that there is the line of sight, the first measurement result is used to determine to activate the wireless sensing service; and/or
in a case that there is no line of sight, the first measurement result is used to determine not to activate the wireless sensing service.

17. The sensing functional entity according to claim 13, wherein in a case of determining not to activate the wireless sensing service, the processor is configured to invoke and run the computer program stored in the memory, to cause the sensing functional entity to further perform:
receiving first indication information, wherein the first indication information is used to indicate that wireless sensing is rejected to be activated or cannot be activated.

18. The sensing functional entity according to claim 17, wherein
the first indication information comprises a reason field, wherein the reason field is used to indicate a reason why wireless sensing is rejected to be activated or cannot be activated.

19. The sensing functional entity according to claim 18, wherein the reason comprises that there is no line of sight or the sensed target is not reachable.

20. The sensing functional entity according to claim 13, wherein a configuration of the wireless signal is indicated by a sensing device, or a configuration of the wireless signal is indicated by a serving base station of the sensed target.
